(19) United States
(12) Patent Application Publication
(10) Pub. No.: US 2007/0292608 A1
(43) Pub. Date: Dec. 20, 2007

(54) Color chips prepared by color clustering used for matching refinish paints

(76) Inventor: Allan Blase Joseph Rodrigues, Bloomfield Hills, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/818,680

(22) Filed: Jun. 15, 2007

Related U.S. Application Data
(60) Provisional application No. 60/814,116, filed on Jun. 16, 2006.

(51) Int. Cl. B05D 3/00; B05D 7/00; B05D 1/02

(52) U.S. Cl. 427/140; 427/421.1; 427/407.1

(57) ABSTRACT

A process for refinishing or repainting a damaged paint area of a vehicle or part thereof using a computer-implemented method to determine a refinish paint formula that can form a refinish matching paint to match the color of the original paint; in this process:
a) a color code which contains color data values of the original paint is acquired;
c) the color code is entered into a computer containing a color cluster database and color clusters and each color cluster has a centroid and refinish paint formula associated therewith;
c) the color clusters associated with the color code of the original paint are identified;
d) color chips that correspond to each of the color clusters identified in step c) using the refinish paint formula associated with the centroid of each of the color clusters are prepared or alternatively color chips provided by a manufacturer of the refinish paint can be used;
e) a matching chip having the closest color match to the original paint is determined visually;
f) the refinish paint associated with the matching chip identified in step e) as the closest color match is selected as the refinish matching paint and spray applied to the damaged paint area by an operator using conventional techniques thereby matching the color characteristics of the refinish matching paint to the undamaged original paint of the vehicle.

### CROSS-REFERENCE TO RELATED APPLICATIONS

This application claims the benefit of U.S. Provisional Application Ser. No. 60/814,116 filed on Jun. 16, 2006 which is hereby incorporated by reference in its entirety.

### BACKGROUND OF THE INVENTION

The present invention is directed to a method for matching the color of a refinish paint to the original paint color on repair or refinish of vehicles like, automobiles, trucks or parts thereof, more particularly, the invention is directed to a computer-implemented method using color chips formed by color clustering techniques for matching paint colors.

Vehicle paint color variability within the same original color can exist due to slight variations in the color of the paint formulations or application conditions used by the original equipment manufacturers (OEM). These variations may occur from one manufacturing location to another manufacturing location, or from one production run to another of a given color on the same vehicle model, or even during the course of a particular production run. Although these differences may be unnoticeable on separate vehicles, when they are present on adjacent body panels, such as, a hood and a fender, of the same vehicle, the differences can be visibly perceptible. These color variations make it difficult to attain an excellent color match in an autobody repair shop.

When a vehicle body is repaired, the repair area usually must be repainted. The color of the repair must match that of the rest of the vehicle such that the repair area is not distinguishable to an observer. The refinish paint available often does not provide a sufficiently close color match since, within a given color code, color generally varies from one vehicle to the next, or even from one part of a vehicle to another. The finisher must then adjust the color of the paint by adding small amounts of colored tints, which in many instances requires the finisher to make several iterations to form a paint having an acceptable color match.

A number of methods have been devised to automate the process of paint matching. A typical method uses a device (e.g., a spectrophotometer) that measures color characteristics of the painted surface and matches the measurements to those archived in a computer database associated with previously developed paint formulas. In this method, the computer database is located at the repair facility. A paint formula having the color characteristics that are closest to those of the painted surface of the vehicle being refinished or repainted is chosen and used to formulate a paint, which is then applied to a test panel and compared to the paint on the vehicle that is being refinished or repainted. Typically, this formulated paint does not adequately match the color of the vehicle being refinished or repainted and must be manually adjusted until a color match is obtained. This is rather inefficient process and significantly affects labor cost of a finishing procedure.

A related method is shown in U.S. Pat. No. 6,522,977, which uses the VIN (Vehicle Identification Number) that contains a serial number that can be associated with the color used on the vehicle and provides that serial number to a central computer, which provides a recommended paint formula that can be used to formulate a paint to refinish or repair the damaged paint on the vehicle. There are provisions in the method that allow for modification of the paint formula to obtain a color match.

Yet another approach is a spectrophotometer based color matching system (e.g., DuPont ChromaVision®). This system measures the color of the paint being matched and calculates a formula to provide a color match. These aforementioned systems, however, do not provide an accurate visual display of the color match. Also, as this system is generally expensive and many users are not willing to pay such a high price.

Patent Application Publication U.S. 2002/0184171 A1 discusses a “System and Method for Organizing Color Values using an Artificial Intelligence Based Cluster Model”. It teaches the use of artificial intelligence methods, including neural networks and fuzzy logic but does not teach specific ways to implement color matching. It teaches the formulation associated with each color group but does not suggest matching the color of a vehicle being repainted to the formula corresponding to the centroid of a color cluster.

Another traditional approach has been to provide color chips of all colors and alternates to these colors that are available. A color chip is simply a color coated panel, which represents an available paint or color formulation. The finisher may then select a target color range, and select a best matched paint formulation from a library of color chips. Unfortunately, this approach also is very expensive for the paint supplier since customers do not expect to pay for the color chips. Also, due to variations in the color chip preparation process, color chips sometimes differ in color properties from the actual target color sprayed by the user.

To provide these color chips of alternate paint formulas, typically, a paint manufacturer will collect vehicle parts from a large number of vehicles and visually inspect them to determine where to position alternates. But these visual judgments are subjective and tedious and if too many alternates are provided, it is confusing and difficult for the refinisher to choose the best alternate. If there are too few, they may not be adequate to allow matching of all vehicles. There is a need for an objective method to optimize the number of alternate paint formulas and their color positions such that all vehicles in that color can be matched by the refinisher using one of the alternates and spray application blending skills.

There is a need for computer-implemented method that will assist the finisher in a repair facility to select an optimum color matched paint in refinishing or repainting of a vehicle or part thereof. This method must utilize instrumental multi-angle color measurements (standard CIE L*,a*,b* values) of the paint on the vehicle or vehicle parts to characterize the color variations of the original color of vehicles that occur, for example, from different manufacturing sites or from entry points into the country, like rail heads and docks. Such a method needs to utilize these measurements, using a computer system to obtain optimum paint formulas and paint chips for each of these formulas that are used to match the color of the paint on the vehicle or part being repaired.

### SUMMARY OF THE INVENTION

The present invention is directed to a process for refinishing a damaged paint area of a vehicle or part thereof with an original paint or repainting of the same using a computer-implemented method to determine a color matchable refinish paint formula that is used to form a refinish matching paint used for repair of the damaged paint area and match the color of the original paint; the process comprises:
a) acquiring a color code for the original paint to be matched wherein the color code references color data values of the original paint;
b) entering the color code into a computer containing a color cluster database and color clusters, wherein each color cluster having a centroid and refinish paint formula associated with each centroid;
c) identifying the color clusters associated with the color code of the original paint;
d) preparing color chips that correspond to each of the color clusters identified in step c) using the refinish paint formula associated with the centroid of each of the color clusters;
e) positioning each of the color chips prepared in step d) on or adjacent to the original paint and visually determining a matching chip having the closest color match;
f) using the refinish paint associated with the matching chip identified in step e) as the refinish matching paint and spray applying the refinish matching paint to the damaged paint area by an operator thereby matching the color characteristics of the refinish matching paint to the undamaged original paint of the vehicle or part thereof using conventional spraying, blending and shading techniques and drying and curing the refinish matching paint.

Another aspect of this invention is to use color chips prepared by a paint manufacturer using color clustering techniques and use these chips to match the color of the original paint on a vehicle.

### BRIEF DESCRIPTION OF DRAWINGS

FIG. 1 is block diagram showing steps for obtaining a color matching paint for vehicle repairing or refinishing.

FIG. 2 is a block diagram showing steps for obtaining a color matching paint for vehicle repair or refinishing using color chips provided by a paint manufacturer.

FIG. 3 is a block diagram showing steps for forming color clusters and centroids for the color clusters.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The invention is useful for matching paint and most particularly for matching paint on vehicles. “Vehicle” includes automobiles; light trucks; medium duty trucks; semi-trucks; tractors; motorcycles; trailers; ATVs (all terrain vehicles); pick-up trucks and includes automobile bodies, any and all items manufactured and painted by automobile sub-suppliers, frame rails, commercial trucks and truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers, recreational vehicles, including but not limited to, motor homes, campers, conversion vans, vans, pleasure vehicles, pleasure craft snow mobiles, all terrain vehicles, personal watercraft, motorcycles, boats, and aircraft. Also included are industrial and commercial new construction and maintenance thereof; cement and wood floors; walls of commercial and residential structures, such office buildings and homes; amusement park equipment; concrete surfaces, wood substrates, marine surfaces; outdoor structures, such as bridges, towers; coil coating; railroad vehicles; machinery; OEM tools; signage; fiberglass structures; sporting goods; and sporting equipment.

CIE L*, a*, b* color coordinate values, herein referred to as “L*, a*, b* color data values” are standard values read by conventional basic color measuring instruments, such as, a portable colorimeter as shown in U.S. Pat. No. 4,917,495 or a spectrophotometer from X Rite Incorporated, Grandeville, Mich., for example, an X Rite SP64 spectrophotometer.

The term “color data value” or “color data values” herein refers to a set of values used to describe a color specified by the CMC (Colour Measurement Committee of the Society of Dyers and Colourists (UK), R. McDonald, Acceptability and Perceptibility Decisions Using the CMC Color Difference Formula, J., Soc. Dyers and Colourists, June 1988 pages 31-37) or International Commission on Illumination, such as, but not limited to, CMC, CIE94, CIEDE2000, and CIELAB (also commonly referred to as L*,a*,b* or Lab). Color data values may also include values produced by other color measurement methods or instruments known to the industry, such as, but not limited to, (1) Hunter L, a, b, wherein L=lightness, a=green and red and b=blue and yellow; (2) CIELCH: a color standard developed from CIELAB; (3) XYZ tristimulus values; and (4) Yxy expression of the XYZ values. L*, a*, b* color data values produced by aforementioned portable calorimeters or spectrophotometers can be used in this invention.

“Color cluster” refers to a cluster of L*, a*, b* color data values taken from measurements of a group of vehicles of the same paint color.

“Centroid” means the center of a color cluster from which a paint formula is calculated via computer implementation, which is matchable by conventional spraying, blending and shading techniques to an original paint color that is within the color cluster.

“Cluster Analysis” is the procedure used to form clusters and determine the size (diameter) of the cluster and the relationship of one cluster to another cluster. Cluster analysis is more fully described in an article “Cluster Analysis”, a tutorial, by N. Bratchell, Chemometrics and Intelligent Laboratory Systems 6 (1989), 105-125, which is hereby incorporated by reference. Another useful reference is “Clustering Methods and their uses in Computational Chemistry” by Geoff M. Down and John M. Barnard, Reviews In Computational Chemistry 18, (2002), 1-40, which also is hereby incorporated by reference.

“Gamut” is the range of colors that can be reproduced in a specific color space or on a specific device.

“Gamut Visualizer” is an instrument that reproduces L*,a*,b* color data values visually on a screen and is utilized to show color clusters and is described in U.S. Patent Publication 2004/0100643 A1, published May 27, 2004, which is hereby incorporated by reference.

The color of the paint is described in L*, a* and b* values which are coordinates in visual uniform color space and are related to X, Y & Z tristimulus values by the following equations which have been specified by the International Committee of Illumination:

L* defines the lightness axis

L*=116(Y/Yₒ)1/3−16

a* defines the red green axis

a*=500[(X/Xₒ)1/3(Y/Yₒ)1/3]

b* defines the yellow blue axis

b*=200[(Y/Yₒ)1/3−(Z/Zₒ)1/3]

where
Xₒ, Yₒ and Zₒ are the tristimulus values of the perfect white for a given illuminant;
X, Y and Z are the tristimulus values for the color.

It is generally well accepted that the three-dimensional color space can be used to define colors in terms of certain color characteristics or color attributes. CIELAB, also commonly referred to as L*,a*,b* and Lab, is a uniform device that shows independent color space in which colors are located within a three-dimensional rectangular coordinate system. The three dimensions are lightness (L*), redness/greenness (a*) and yellowness/blueness (b*). In a typical three dimensional graph used to illustrate these color data values, the vertical axis which is L*, the black/white axis, represents a scale of luminous intensity or degree of lightness. The axis perpendicular to the plane of the graph or figure, the a* axis, is the red/green axis which represents a scale of red/green appearance. The horizontal axis is the b* axis which is the yellow/blue axis and represents a scale of yellow/blue appearance.

The information contained in the combination of a color's a*-b* axes position represents the chromatic attributes known as hue and saturation. The hue varies with the position about the L* axis and the chroma changes with the distance from the L* axis.

Chroma=C*=\sqrt{a*²+b*²}

Hue=h=tan⁻¹ (b*/a*);

this is referred to as the hue angle.

Therefore, a complete set or group of color attributes, or the attributes defining coordinates comprising lightness (L*), red/green (a*), and yellow/blue (b*) in the L*,a*,b* color space, fully defines a color point or locus in the color space. When generally used herein, the term “color” shall be understood to be fully defined by one or more complete sets or groups of color attributes or corresponding coordinates considering all three dimensions or axes in a three dimensional color space.

Color is usually judged versus a color standard, with color measurements expressed as a color difference versus that standard.

ΔL*=L*sample−L*standard

Δa*=a*sample−a*standard

Δb*=b*sample−b*standard

ΔC*=C*sample−C*standard

A total color difference is expressed as

ΔE*=\sqrt{ΔL*²+Δa*²+Δb*²}

The hue difference is expressed as a metric hue difference rather than a hue angle difference

ΔH*=k\sqrt{ΔE*²−ΔL*²−ΔC*²}

or ΔH*=k\sqrt{2(C*₂C*_{b}−a*ₛa*_{b}−b*ₛb*_{b})}
where, if a*ₛb*_{b}>a*_{b}b*ₛ [symbol] k=1; otherwise k=−1 subscripts s and b refer to standard and sample.

Transformations of CIELAB space have been published in order to make it agree better with visual assessments. The general equation is

$$Δ E = {[ {( \frac{Δ {L}^{*}}{{K}_{L} {S}_{L}} )}^{2} + {( \frac{Δ {C}_{ab}^{*}}{{K}_{C} {S}_{C}} )}^{2} + {( \frac{Δ {H}_{ab}^{*}}{{K}_{H} {S}_{H}} )}^{2} ]}^{0.5}$$

The CIE94 color space and a method described by Rodrigues et al (Rodrigues, A. B, J. and Locke, J. S., Proceedings of the 9th Congress of the International Colour Association, SPIE Vol. 4421 (2001), page 658-661) defines the parameters

S_{L}=1.0 for solid colors

S_{L}=0.034L*; If L*≦29.4, S_{L}=1.0 for gonioapparent colors

S_{c}=1+0.045C*_{ab}

where C*_{ab}=SQRT(C*_{standard}.C*ₛₐₘₚₗₑ)

S_{H}=1+0.015C*_{ab}

The parametric factors K_{L}:K_{C}:K_{H}=1:1:1 are generally satisfactory

Other commonly used color spaces are CMC and CIEDE2000

Color can be further described at a variety of refection angles, L(θ), a(θ) and b(θ), where θ is the particular reflection angle as measured from the specular direction. Commercial multi-angle calorimeters and spectrophotometers are widely available and are useful in measuring the L*, a* and b* values at several angles in one reading. Instruments often allow 5-10 angles of measurement, including multiple angles of illumination. Preferably, the following angles are used: 15°, 45°, and 110° as measured from the specular angle when the color being matched contains metallic or pearlescent flakes. For solid colors, the 45° angle is sufficient, or even diffuse measurements, integrating the light reflected at all angles.

The aforementioned prior art methods for developing matching refinish paint formulations, e.g., using a spectrophotometer, color chips, alternate refinish color formulations, generally resulted in a large number of paint formulas that could be used and made it very difficult for a refinish operator to choose the closest color matching paint formula with any level of assurance that the paint could be colored matched. Often panel spray test runs were made and if a match could not be obtained, the formula was slightly adjusted or another formula chosen to provide a closer match.

The process of this invention by the use of color chips that are directly associated with centroids of color clusters that are developed to match original paints on vehicles allows a refinish operator to make a choice of a paint formula that has a high level of assurance that the color of the resulting refinish matching paint will be color matchable to the original paint using standard application techniques.

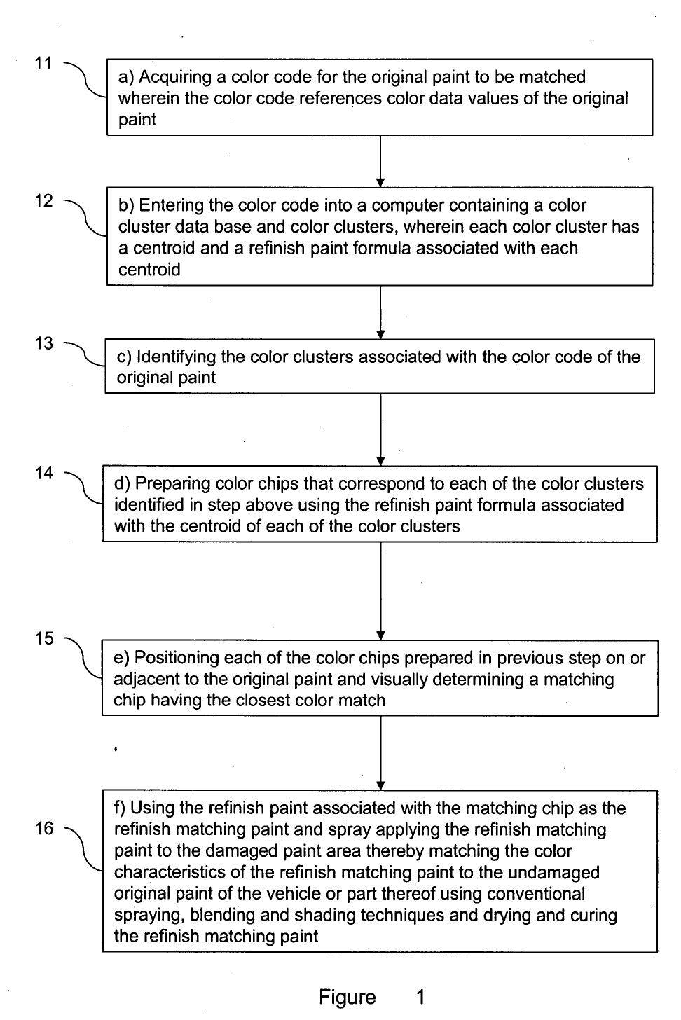

FIG. 1 shows the procedure for obtaining a color matching refinish paint for repairing or repainting a vehicle using the color chips related refinish paint formulas for the centroids of the color clusters that have been developed. The color code of the original paint is obtained which is associated with L*, a*, b* values of the original paint on a vehicle that is to be refinished or repainted (Box 11, FIG. 1). The color code typically is affixed to the vehicle, for example, on the side of the left front door or can be obtained from the vehicle manufacturer by identifying the make, model, model year and color of the vehicle. This code is entered into a computer equipped with a program that contains the paint formulas for the centroids of the color clusters that are related to the original color (Box 12 and 13, FIG. 1). The refinish operator can prepare paint chips using the refinish paint formulas for each of the identified centroids. Alternatively, paint chips of these paint formulas of the centroids can be provided by the paint manufacturer (Box 14, FIG.1). The color chips are positioned on or adjacent to the original paint of the vehicle or part thereof and the operator visually determines which chip has the closest color match (Box 15, FIG. 1). A color chip that provides the closest color match is determined as a matching chip. The refinish paint associated with the matching chip is determined as a refinish matching paint. The refinisher uses conventional paint spraying, blending and shading techniques and spray applies the refinish matching paint to the vehicle matching the original color of the vehicle and the paint is then dried and cured using conventional techniques (Box 16, FIG. 1).

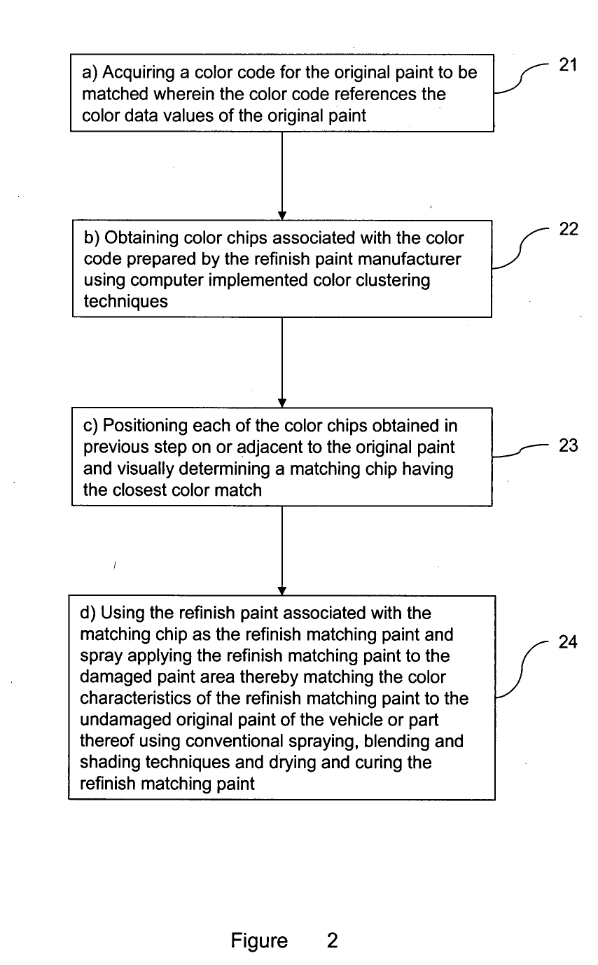

FIG. 2 shows an alternate procedure for obtaining a color matching refinish paint for repairing or repainting a vehicle. The color code for the vehicle is obtained as discussed above (Box 21, FIG. 2). Then color chips are obtained from a refinish paint manufacturer that are directly associated with the color code for the vehicle. These chips are prepared by the manufacturer of the refinish paint using computer implemented color clustering techniques as described above. In this situation, the refinish paint manufacturer prepares color chips associated with the particular paint rather than the refinish operator. As discussed above the refinish operator places the paint chips on or adjacent to the original paint being refinished and the closest visual color match is obtained (Box 23, FIG. 2) and the refinish operator uses conventional spraying, blending and shading techniques to color match the original paint (Box 24, FIG. 2).

To implement the process of this invention for the development of color chips for refinish paint formulas, a color cluster database must be developed for a specific color of a vehicle. Since there are variations in color even from the same manufacturing facility and from different manufacturing facilities, color data values (CIE L*,a*,b* color data values) preferably is obtained for at least thirty vehicles from different locations and vehicles made at different times. Original paint color data values (CIE L*, a*, b* values) of each vehicle are obtained at multiple angle. Preferably 3 angles are used, 15°, 45° and 110°. For vehicles manufactured overseas, measurements are taken at entry ports, rail-heads and similar locations where there are large groups of vehicles assembled.

Via computer implementation, the color data is compared to and positioned in color clusters for the particular paint color that is to be matched and a paint formula of a refinish paint for the centroid of that color cluster is identified and developed in a laboratory. The refinish paint is formulated according to the formula for the centroid. This refinish paint is spray applied to form color chips either by the paint manufacturer or by an operator skilled in the art. The resulting paint chips are placed on or adjacent to the paint surface to be color matched and the operator visually selects the chip that provides the closest color match. The operator then spray applies the refinish paint corresponding to the selected color chip using standard spraying, blending and shading techniques to match the color of the undamaged original paint. For flake containing paints, visual comparison is usually required to determine that appearance of the flake, for example, color flop, flake sparkle and texture is acceptable. The applied refinish paint is subsequently dried and cured using standard techniques.

In determining the volume of a color cluster, all of the data points within the cluster will be color matched by conventional blending techniques using the formula of the centroid of the cluster. The cluster is mapped in multi-dimensional color space that allows for the three dimensions of color and the multiple angles at which it is measured. The use of visually uniform color space, such as, CIE94 allows the three dimensions of color space to be weighted equally. It may be desirable to weight the measurement angles for customer preference in determining the volume of the color cluster for blendable color matching paint. The multiple angles of measurement are weighted to allow for customer preferences. For example, when approaching a vehicle and judging color acceptability of a paint repair, especially on a horizontal surface, the 110° angle is the most noticeable and should be weighted the highest. On the other hand, some customers place a greater emphasis in color match when viewed very close to the mirror or specular angle of reflection of the light source. In such a case, the 15° angle should be weighted higher.

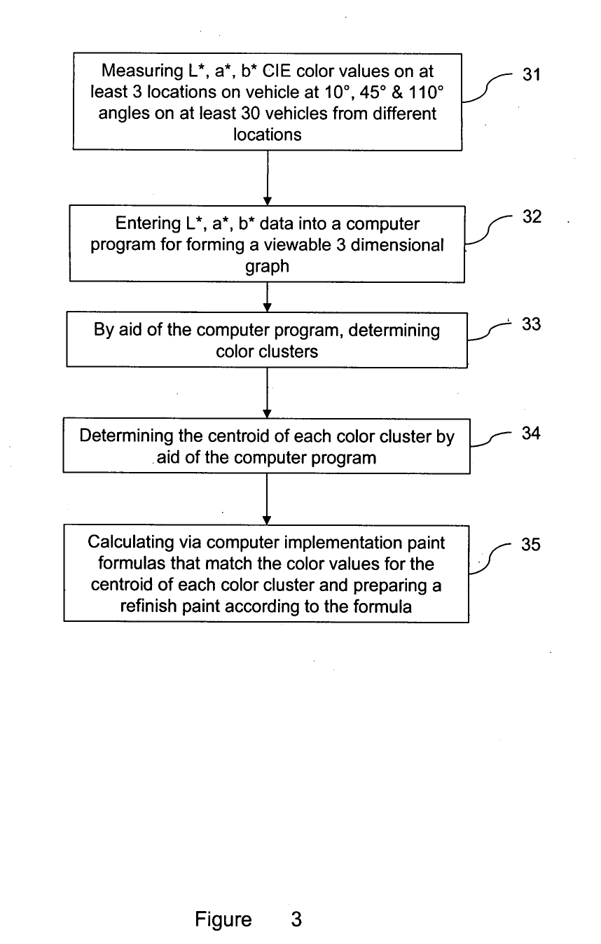

FIG. 3 is a block diagram showing a procedure for forming color clusters and centroids of the color clusters and for determining the matching paint formulas for the centroids. Box 31, of FIG. 3 shows that for a given color, the L*, a*, b* CIE color data values are measured preferably on at least 30 vehicles, at least 2 different places on the vehicle, typically on a horizontal surface, such as, the roof or hood and on a vertical surface, such as, a side door or side panel and measured at three different angles, preferably, 15, 45 and 110 degrees using an color measuring instrument, such as, the aforementioned colorimeter or spectrophotometer.

Box 32 of FIG. 3, shows that the L*, a*, b* values are entered into a computer and the program provides a three dimensional graph having L*, a*, b* co-ordinates. Box 33 of FIG. 3 shows that by aid of a computer program, color clusters are determined. Box 34 of FIG. 3 shows that the centroid of each color cluster is determined by aid of a computer program using Cluster Analysis techniques.

A Gamut Visualizer can be used to display the aforementioned data.

The computer program utilizes Cluster Analysis techniques to determine the size of the color cluster, the number of clusters, the distance between clusters and the centroid of each cluster.

Cluster Analysis techniques are described in detail in an article “Cluster Analysis” by N. Bratchell, and “Clustering Methods and their uses in Computational Chemistry” by Geoff M. Down, and John M. Barnard, supra. From these articles, those skilled in the art can readily determine useful color clustering techniques used for determining color clusters, the size and diameter of color clusters, the distance between color clusters and the centroid of each color cluster.

Box 35 of FIG. 3 shows that a refinish paint formula is calculated that matches the L*, a*, b* color data values of the centroid of each color cluster. A refinish paint having these color data values is formulated in a laboratory by a skilled technician and is available to the person refinishing or repairing the vehicle.

When new vehicle colors are introduced, refinish paint suppliers receive color standards. These standards can be matched through visual methods or commercial computer color matching programs, such as, Datamatch® (Datacolor, Lawrenceville, N.J.). The color difference between the color data values of the centroid and this first match can then be adjusted using the same commercial software or methods such as disclosed in Armstrong et al, U.S. Pat. No. 3,690,771 issued Sep. 12, 1972 which is hereby incorporated by reference. Other commercially available color shading programs are available from GretagMacBeth LLC New Windsor, N.Y., USA.

The important point of the novel process of this invention is that if an original paint color falls within a color cluster, the paint formula directly derived from the centroid of the color cluster will be matchable to the original paint of the vehicle being refinished by a skilled technician using standard spraying, blending and shading techniques.

The novel process of this invention can be used to match finishes on vehicles having a standard pigmented mono coats, clearcoat/pigmented basecoat or tri-coat finishes and can be used to match solid color as well as coatings containing metallic flake and or special effect imparting pigments.

The present invention is further defined in the following Example. It should be understood that this Examples is provided by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative example set forth herein below, but rather is defined by the claims contained herein below

The following Example illustrates the invention.

### EXAMPLE

L*,a*,b* color data values were determined for several vehicles coated with Light Sapphire Blue paint Ford 6993. L*,a*,b* color data values were measured using an X-Rite MA 90B Metallic Field Colorimeter made by X-Rite Incorporated, Grandville, Mich. Color data values were taken on the hood and on the driver's side door of each vehicle. L*,a*,b* color data values were recorded at these two locations on the vehicle at 15°, 45° and 110° viewing angles

All of the L* a* b* color data values determined above for each of the angles 15°, 45° and 110° were evaluated using cluster analysis techniques described in “Cluster Analysis” and “Clustering Methods and their uses in Computational Chemistry” by Geoff M. Down, and John M. Barnard, supra, whereby a color cluster diameter and distance between color clusters was set and a centroid was determined for each color cluster. A centroid was determined for each of the two optimized color clusters and designated as Alternate A and Alternate B. The L*, a*, b* values for these centroids at each angle are shown in the table below. A refinish paint formula was determined to match each of these centroids and color chips were prepared by spraying these paints onto a conventional substrate used to form color chips and dried and cured using conventional techniques well known to those skilled in the art. These chips were positioned adjacent to the original paint on the vehicle to be repaired. Visually comparing them to the vehicle, Alternate B appeared darker, greener and more blue compared to the vehicle at most viewing angles. It also appeared too red compared to the vehicle when viewed at grazing angles, close to 110 degrees. Alternate A appeared to be a good color match and was selected to repair the vehicle. Once painted, the repair area was not distinguishable from the rest of the vehicle because the repair paint was a good color match.

The original color of the vehicle was measured for verification. In Table 1 below, the L*, a*, b* readings at the three angles are shown. Tables 2 and 3 show the L*, a*, b* values for Alternate Paints A and B and the difference between these values and the values of the original paint of Table 1. These calculated color differences for the two alternates paints versus the original paint of the vehicle are in agreement with the visual assessments above, i.e., Alternate Paint A provided the better color match. This measurement was only for verification and is not necessary to practice this invention.

TABLE 1
L*, a* and b* Values for the Original Paint of the Vehicle

| Angle | L* | a* | b* |
|---|---|---|---|
| 15 degree | 69.07 | −10.95 | −20.02 |
| 45 degree | 34.88 | −6.23 | −14.77 |
| 110 degree | 14.50 | −3.23 | −12.36 |

TABLE 2
L*, a* and b* Values for Alternate Paint A and Difference
Values Between Original Paint and Alternate Paint A

| Angle | L* | a* | b* | ΔL* | Δa* | Δb* |
|---|---|---|---|---|---|---|
| 15 deg. | 69.81 | −11.01 | −20.07 | 0.74 | −0.06 | −0.05 |
| 45 deg. | 35.13 | −6.8 | −14.56 | 0.25 | −0.57 | 0.21 |
| 110 deg. | 14.27 | −3.18 | −12.07 | −0.23 | 0.05 | 0.29 |

TABLE 3
L*, a* and b* Values for Alternate Paint B and Difference
Values Between Original Paint and Alternate Paint B

| Angle | L* | a* | b* | ΔL* | Δa* | Δb* |
|---|---|---|---|---|---|---|
| 15 deg. | 67.15 | −15.52 | −21.07 | −1.92 | −4.57 | −1.05 |
| 45 deg. | 32.93 | −7.74 | −16.23 | −1.95 | −1.51 | −1.46 |
| 110 deg. | 14.37 | −1.14 | −14.00 | −0.13 | 2.09 | −1.64 |

What is claimed is:

1. A process for refinishing a damaged paint area of a vehicle or part thereof with an original paint using a computer-implemented method to determine a color matchable refinish paint formula used to form a refinish matching paint being used to repair the damaged paint area and match the color of the original paint; said process comprising:
a) acquiring a color code for the original paint to be matched wherein the color code contains color data values of the original paint;
b) entering the color code into a computer containing a color cluster database and color clusters, wherein each color cluster having a centroid and a refinish paint formula associated with each centroid;
c) identifying the color clusters associated with the color code of the original paint;
d) preparing color chips that correspond to each of the color clusters-identified in step c) using the refinish paint formula associated with the centroid of each of the color clusters;
e) positioning each of the color chips prepared in step d) on or adjacent to the original paint and visually determining a matching chip. having the closest color match;
f) using the refinish paint associated with the matching chip identified in step e) as the refinish matching paint and spray applying the refinish matching paint to the damaged paint area by an operator thereby matching the color characteristics of the refinish matching paint to the undamaged original paint of the vehicle or part thereof using conventional spraying, blending and shading techniques and drying and curing the refinish matching paint.

2. The process of claim 1, wherein the refinish matching paint is a repair basecoat for repairing a basecoat/clearcoat finish.

3. The process of claim 1 wherein the refinish matching paint is a pigmented repair mono coat for repairing a pigmented mono coat finish.

4. The process of claim 1 wherein the color data values, the color cluster database and the color clusters comprise L*, a*, b* color data values.

5. The process of claim 4 wherein the L*, a* and b* values are measured at three different angles wherein the three angles are identical to those angles used to measure the original paint color.

6. The process of claim 5 wherein the original paint contains solid color pigments, special effect pigments, metallic flake pigments or any mixtures thereof.

7. The process of claim 4 wherein the color cluster database comprises L*, a*, b* color data values taken at least three different viewing angles for a specific color determined from at least three readings from different areas of the vehicle from vehicles made by the same manufacturer at least at one vehicle manufacturing site.

8. The process of claim 4 wherein each of the values of the color cluster database are plotted on video screen as a three dimensional layout.

9. The process of claim 1 or 7 wherein color clusters in the color cluster database are determined via computer implementation using standard statistical techniques, a centroid is determined for each cluster and a refinish paint formula is determined via computer implementation for the centroid of each color cluster and color chips are prepared using the refinish paint for the centroid of each color cluster.

10. The process of claim 8 wherein color clusters in the color cluster database are determined via computer implementation using standard statistical techniques, a centroid is determined for each cluster and a refinish paint formula is determined via computer implementation for the centroid of each color cluster.

11. The process of claim 8 wherein a color gamut visualizer is used to view color clusters and centroids for each color cluster.

12. A process for refinishing a damaged paint area of a vehicle or part thereof using a computer-implemented method to determine a color matchable refinish paint formula used to form a refinish matching paint being used to repair the damaged paint area and match the color of the original paint; said process comprising:
a) acquiring a color code of the original paint to be matched;
b) obtaining color chips from a paint manufacturer directly associated with the color code of the original paint to be matched; whereby the paint chips are prepared according to color clustering techniques utilizing a computer containing color data values, a color cluster database and color clusters of the paint; wherein each color cluster identified by color cluster techniques has a centroid and a refinish paint formula associated with each centroid and paint chips are prepared by the paint manufacturer for each of the paint formulas;
c) positioning each of the color chips prepared by the paint manufacturer for each refinish paints prepared from the refinish paint formula of step b) on or adjacent to the original paint and visually determining the closest color match and
d) using the refinish paint associated with the color chip identified in step c) as the refinish matching paint and spray applying the refinish matching paint to the damaged paint area by an operator thereby matching the color characteristics of the refinish matching paint to the undamaged original paint of the vehicle using conventional spraying, blending and shading techniques and drying and curing the refinish matching paint.
